(19) United States
(12) Patent Application Publication
(10) Pub. No.: US 2002/0198857 A1
(43) Pub. Date: Dec. 26, 2002

(54) Normalized detector scaling

(75) Inventor: George Alfred Velius, Wildwood, MO (US)

Correspondence Address: TRADEHARBOR, INC., 390 S. WOODS MILL RD., CHESTERFIELD, MO, 63017-3489, US

(73) Assignee: TradeHarbor, INC., St. Louis, MO (US)

(21) Appl. No.: 09/886,824

(22) Filed: Jun. 21, 2001

(51) Int. Cl. G06F 17/00

(52) U.S. Cl. 706/48

(57) ABSTRACT

Normalized Detector Scaling is the transformation of output data from pattern recognition systems that allows decision rules or operating criteria for the pattern recognition system to be established simply, and independently of the particulars of the pattern recognition system. This is achieved by combining information from the probability distributions that describe the pattern recognitions systems output statistics for the classes of interest. The probability distributions are transformed into an intuitive one-dimensional scale providing both flexibility and convenience in the operation or administration of a pattern recognition system.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains to the transformation of output data from pattern recognition systems. The output data is used in establishing decision rules or operating criteria in the deployment and administration of pattern recognition systems.

2. Background Information

Pattern recognition systems are being used in many practical applications today. Their principle task is to classify items based on measurements of various features or properties. Pattern recognition systems can be described as being either parametric or non-parametric systems¹. ¹Duda, Richard O., Hart, Peter E., Pattern Classification and Scene Analysis, John Wiley & Sons, Inc., 1973, ISBN: 0-471-22361-1, chapter 4.

A parametric pattern recognition system generally embodies a well-defined formula that determines the classification of an item directly from features of the item. The formula must be able to simultaneously model all of the classes of interest to the system. As an example, a pattern-recognition system that determines the proportion of healthy red-blood cells may be based on a simple formula or equation. Since it has been observed that healthy blood cells are generally spherical, and unhealthy blood cells are elongated or sickle-shaped, the equation H=A/C may be used to formulize the ‘sphericity’ or health H of a cell by estimating the area A of the cell, and dividing it by an estimate of the circumference C of the cell. With a suitable decision threshold t, and by using the estimated values of A and C, the classifier can decide that a cell is healthy if H>t, and unhealthy if H≦t. A parametric pattern recognition system is schematically depicted in FIG. 1.

A non-parametric pattern recognition system will separately model the class or classes of items to be detected, and compare features of an unclassified item against the reference models from known classes. This is schematically depicted in FIG. 2. As an example, a military defense radar system may be able to recognize any of the known types of enemy aircraft by their specific relative dimensions. If the enemy has built a new and different type of aircraft, the radar system (if functioning properly) should classify the new aircraft type as “unknown”. Here the final pattern recognition system output is based on a set of comparisons, and the decision rules may be more complex.

In the simplest case there is only one class of item to be recognized. When there is only one class of interest to the pattern recognition system we shall refer to this as the authentic class. If a test item does not belong to the authentic class, it belongs by default to the class of all other items we shall refer to as the spurious class. Deciding if a test (i.e. as yet unclassified) item does indeed belong to the authentic class has been referred to as the ‘signal detection’ problem². In ‘signal detection’ literature, the authentic distribution is referred to as the signal distribution, and the spurious distribution is referred to as the noise distribution. The terms ‘signal’ and ‘noise’ have taken on new usage, especially in the area of digital signal processing, and we therefore prefer the terms ‘authentic’ and ‘spurious’, for clarity. ²Green, David M., Swets, John A., Signal Detection Theory and Psychophysics, 1989, ISBN: 0932146236.

For either parametric or non-parametric pattern recognition systems, some statistic is computed based at least in part on the features of an item. Pooling observations of the statistic induces a probability distribution. In practice, probability distributions of both the authentic and spurious classes are determined experimentally to assess the overall performance of the pattern recognition system. An illustration of both authentic and spurious probability distributions is given in FIG. 3.

The decision regarding the classification of a test item is made on the basis of some threshold or decision criterion. The criterion is generally selected at least in part on the basis of the authentic and spurious probability distributions. After the probability distributions for both the authentic and spurious classes are known, and once a threshold is selected, the probability of the system making an error can be computed. There are always at least two types of errors possible, false-rejections, and false-acceptances, also known as Type I and Type II errors respectively. These are illustrated in FIG. 4.

Assessing the performance of a recognition system is important if one is considering using the pattern recognition system as a solution to some recurring problem, or as a tool in some recurring task. But in the course of using a pattern recognition system one has to define a decision rule, also known as a test of an hypothesis³, that will be employed. The decision rule may be as simple as selecting a threshold based on the probability distributions for the authentic and spurious classes, such as was suggested above where the classifier can decide that a cell is healthy if H>t, and unhealthy if H≦t . We refer to the set of all possible decision rules for a given pattern recognition system as the decision space. ³Lindgren, Bernard W., Statistical Theory, 3^{rd} Ed., Macmillan Publishing Co., Inc., New York, N.Y., 1976, ISBN: 0-02-370830-1, Page 277.

In selecting a decision rule one may consider the tradeoffs of the two types of error that are possible. In FIG. 4, moving the decision threshold to the left would decrease the probability of a false-acceptance, and would increase the probability of a false-rejection. Methods for analyzing the tradeoffs are well known. The function that portrays the tradeoffs between false-rejections and false-acceptances is known as the operating characteristic, and is dependent on the decision rule⁴. Other methods of depicting the two-dimensional error-tradeoff problem have also been recently suggested⁵. These methods for analyzing the tradeoffs, along with other examples⁶, serve to illustrate that the problem of selecting a decision rule is typically treated in a two-dimensional space. ⁴Kreyszig, Erwin, Advanced Engineering Mathematics, John Wiley & Sons, New York, 5^{th} Edition, 1983, ISBN: 0-471-86251-7, page 960. ⁵Martin, A. et al. “The DET Curve in Assessment of Detection Task Performance”, EuroSpeech 1997 Proceedings Volume #4, pp. 1895-1898 ⁶Daugman, “Biometric personal identification system based on iris analysis,” U.S. Pat. No. 5,291,560, Mar. 1, 1994.

In practice, decision rules are often dependent on a particular statistic used, and on the particular conditions for which the probability distributions of the authentic and spurious classes were determined. In general, if the statistic or the original conditions change, the decision rule too must be changed to continue operating the pattern recognition system in an optimal fashion. If, for example, we wanted to add a new feature, say the color of the cell, to our blood cell classifier, we would need a new decision rule.

As a second example, consider an adaptive speaker identity verification system where the operating criterion is defined so that the probability of a false-rejection always equals the probability of a false-acceptance. The system performance at this criterion is known as the Equal Error Rate (EER). A person's speech is modeled from multiple instances of speaking the same phrase in order to capture the inherent variability in pronunciation. With only one exemplar of a person's speech, the system may achieve an EER of 4%, while the same system, with two exemplars of the person's speech may achieve an EER of 2% by essentially reducing the variance in the authentic distribution. The decision rule for one exemplar, based on a simple threshold, must be different from the decision rule for two exemplars because the threshold for performing at the EER is different, because the authentic distribution is different.

The task of operating a pattern recognition system would be simplified if decision rules could be established in a way that is independent of the features, or the particular statistics employed by the pattern recognition system. Finding a way to establish decision rules that are independent of the features, or the statistics employed, is essential for pattern recognition systems that adapt to changing conditions or learn about their particular task over time. For some applications, the user of a pattern recognition system may not wish to delve into statistical analysis of performance trade-offs, and yet may wish to have some control over the system's decision criteria.

### BRIEF SUMMARY OF THE INVENTION

In view of the foregoing, the present invention, through one or more of its various aspects, embodiments and/or specific features or subcomponents thereof, is thus intended to bring about one or more of the objects and advantages as specifically noted below.

A general object of the present invention is to provide a simpler means of establishing the decision criteria for a pattern recognition system than is generally afforded by traditional methods such as operating characteristic analysis.

More specifically, an object of the present invention is to provide a Normalized Detector Scaling method that utilizes the class-specific probability distributions of a pattern recognition system to make the selection of the operating criteria independent of the particulars of the pattern recognition system. This being accomplished by transforming the pattern recognition system output statistics to a well-defined, one-dimensional scale.

Another object of the present invention is to provide an intuitive interface for decision criteria selection to those operating a pattern recognition system.

### BRIEF DESCRIPTION OF THE SEVERAL VIEWS OF THE DRAWING

For a more complete understanding of the present invention and the advantages thereof, reference should be made to the following Detailed Description of the Invention taken in connection with the accompanying drawings in which:

FIG. 1 is a schematic diagram of a parametric pattern recognition system;

FIG. 2 is a schematic diagram of a non-parametric pattern recognition system;

FIG. 3 is an illustration of the probability distributions of a pattern recognition system's fundamental classes, that is, the authentic and the spurious classes;

FIG. 4 is an illustration of the error probabilities of a pattern recognition system with respect to the authentic and spurious class probability distributions;

FIG. 5 is a schematic diagram of a non-parametric pattern recognition system with Normalized Detector Scaling; and

FIG. 6 is a block diagram overview of the setup and operation of Normalized Detector Scaling in a pattern recognition system.

FIG. 7 is an illustration of the probability distributions of a pattern recognition system's fundamental classes, that is, the authentic and the spurious classes, where the output statistics represent similarities.

FIG. 8 is an illustration of the cumulative probability distributions of a pattern recognition system's fundamental classes, that is, the authentic and the spurious classes, where the output statistics represent similarities.

FIG. 9 is a graphic illustration of the combined range of both the authentic and spurious cumulative probability distributions segmented into four regions.

FIG. 10 illustrates the mapping of region A into a linear representation of cumulative probability.

FIG. 11 is a graphic illustration of the ratio of false-rejection to false-acceptance error probabilities in the vicinity of regions B and C.

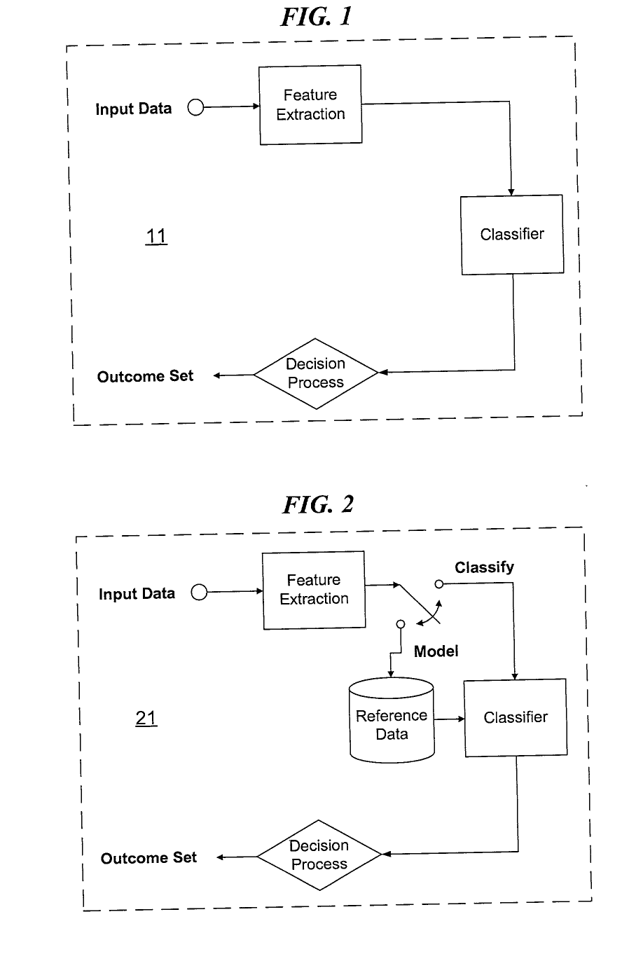

Similar reference characters refer to similar parts and/or steps throughout the several views of the drawings.

### DETAILED DESCRIPTION OF THE INVENTION

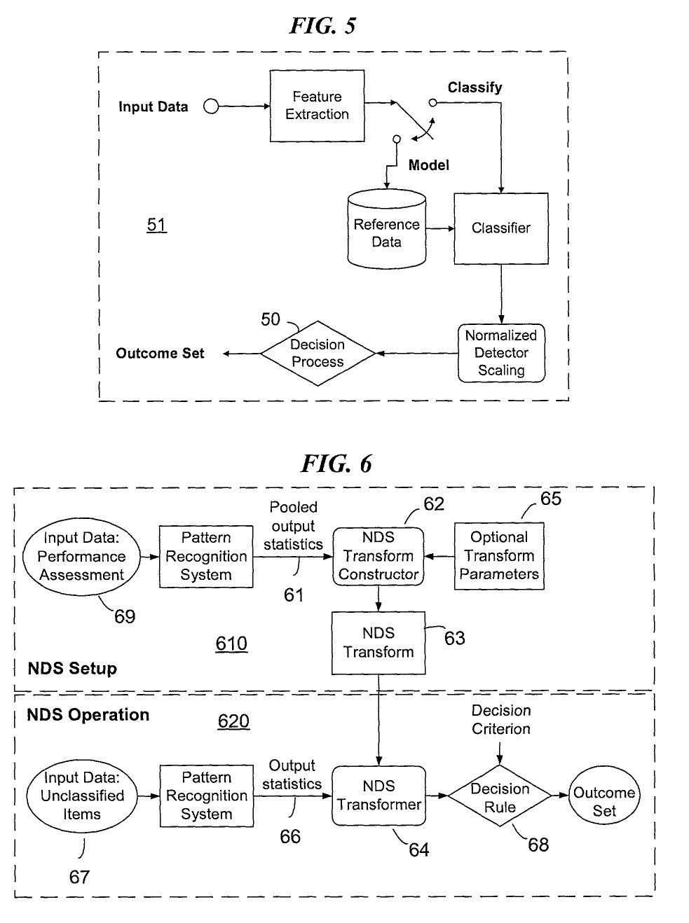

Normalized Detector Scaling (NDS) represents a means of providing context independent decision rules 50 for operating a pattern recognition system 51. NDS also provides the user of a pattern recognition system a simpler means of controlling the decision criterion. This comes at the cost of an additional complexity in the pattern recognition system 51, as compared to either parametric 11, or non-parametric 21 pattern recognition systems. The pattern recognition system must be able to provide output statistics 61 for the authentic 31 and spurious 32 class-specific probability distributions. The case of non-parametric pattern matching with NDS 51 is illustrated schematically in FIG. 5.

As shown in FIG. 6, the NDS method may be described in three parts, the NDS transform constructor 62, the NDS transform 63, and the NDS transformer 64. In the NDS setup phase 610, the NDS transform 63 is constructed, or modified, by presenting performance assessment data 69 that consists of input items of known classification.

The NDS transform constructor 62 takes as input the pooled output statistics 61, or the probability distributions of the pattern recognition system. The NDS transform constructor 62 also takes as input optional transform parameters 65 that may serve, for example, to tailor or focus the NDS transform on a particular region of interest in the decision space.

The NDS transform constructor 62 produces the formulae, parameters, procedures, mapping functions, or the like, referred to as the NDS transform 63, that will be used in transforming the output statistics 66 of the pattern recognition system to a new decision space.

In operation on unclassified input items 67, the pattern recognition system output statistics 66 are presented to the NDS transformer 64 that uses the NDS transform 63 to convert the output statistics 66 to the new decision space.

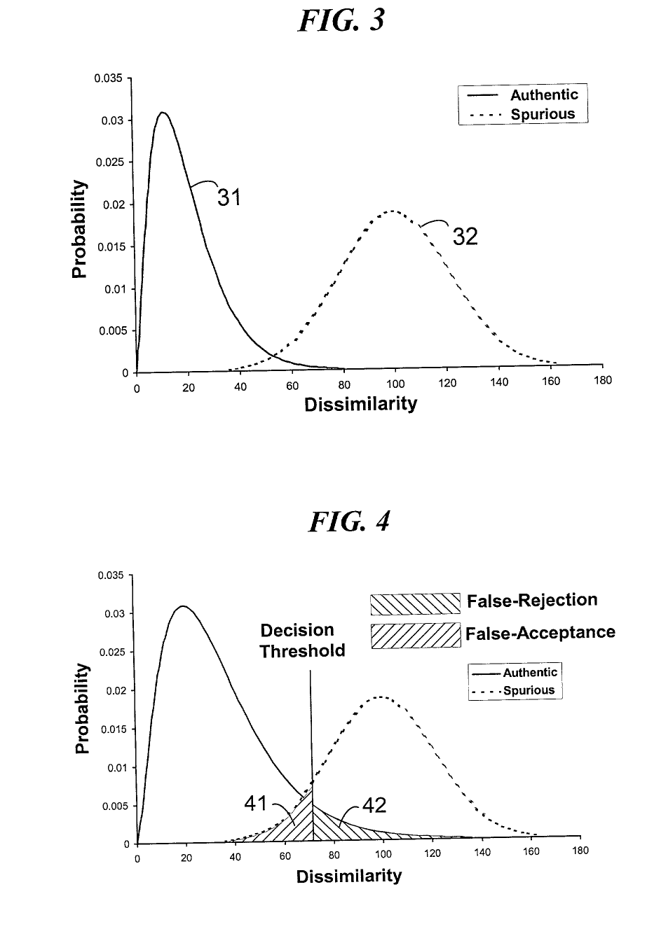

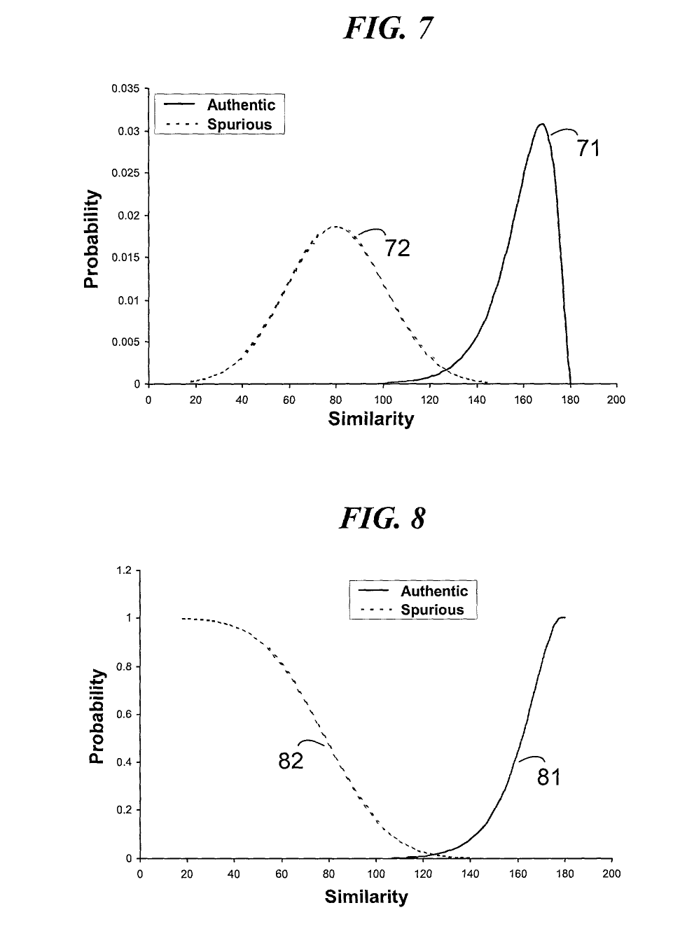

The NDS transform constructor 62 relies on the pattern recognition system's pooled output statistics 61, which are essentially represented by the probability distributions for the authentic 31 and spurious 32 classes. If these output statistics 61 represent dissimilarities, i.e. numbers that increase as the match to a known class decreases, the dissimilarities d, are converted to similarities s, so that the intuitive notion of “bigger is better” is utilized. This can be done as simply as s=dₘₐₓ−d. FIG. 7 illustrates the authentic 71 and spurious 72 distributions of FIG. 3 converted from a scale of dissimilarity to a scale of similarity.

Information from both the authentic 71 and spurious 72 probability distributions are combined by some method to sufficiently simplify the decision criteria selection so that only a single number has to be selected for operation of the pattern recognition system. One such method produces a scale with two segments. Another such method produces a segmented scale with four regions. The regions are based on the cumulative probability distribution functions of the authentic 81 and spurious 82 classes. The cumulative distribution functions may be computed as follows:

$${P}_{A} ( x < K ) = {\int }_{- ∞}^{K} {p}_{A} ( λ ) ⅆ λ$$

$${P}_{S} ( x > K ) = {\int }_{K}^{∞} {p}_{S} ( λ ) ⅆ λ$$

where p_{A} and p_{S} represent the probability distributions of the authentic and spurious classes respectively, and λ is simply a ‘dummy’ variable to describe the integration in its proper form. The cumulative probability distributions are illustrated in FIG. 8.

The four regions of the scale have the following general attributes regarding the pattern recognition system results concerning the authenticity of the test item:

A. Highly unlikely to be authentic 91,

B. Relatively unlikely to be authentic 92,

C. Relatively likely to be authentic 93,

D. Highly likely to be authentic 94.

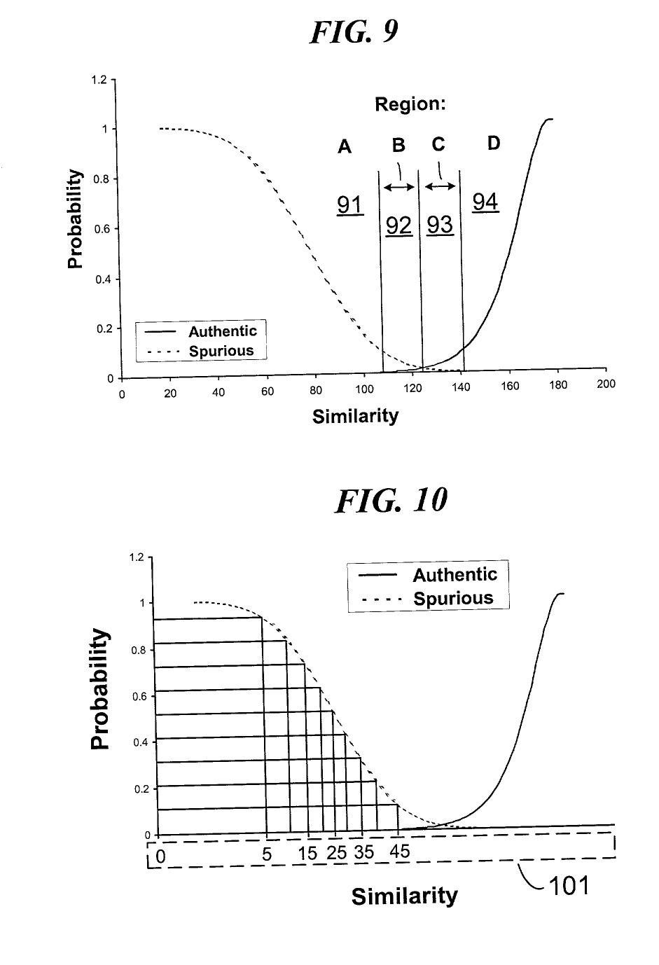

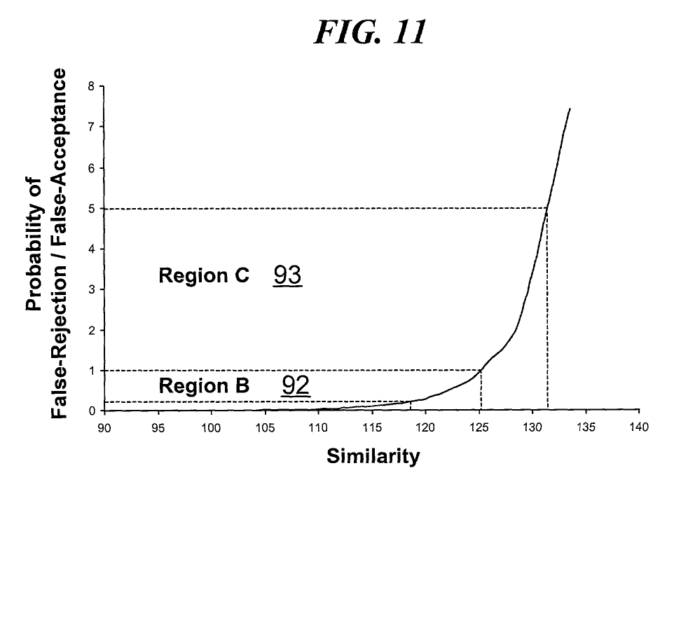

These regions are graphically illustrated in FIG. 9. Each of these regions is then mapped into a part continuous scale. Region A 91 is mapped into a scale that is linear in cumulative probability 101. Region D 94 is also mapped into a scale that is linear in cumulative probability. Regions B 92 and C 93 are mapped into a scale that is linear in the ratio of false-rejection 41 to false-acceptance 42 probabilities. The resultant continuous scale ranges from 0 to 100 inclusive. The value of 0 is reserved to mean that no signal was present. That is, the test item presented to the pattern recognition system did not provide any information to the pattern recognition system. The value of 100 is reserved to mean that the test item is identical to, or exactly matches, a reference model. The value of 50 is reserved to refer to a test item whose similarity is observed to be that of the criterion for the EER. Each region is separately mapped onto the scale from 0 to 100, referred to as the Normalized Detector Scale, by some well-known technique such as linear interpolation.⁷ FIG. 10 illustrates the mapping of region A into a linear representation of cumulative probability 101. FIG. 11 is a graphic illustration of the ratio of false-rejection 41 to false-acceptance 42 error probabilities in the vicinity of regions B 92 and C 93. ⁷Kreyszig, Erwin, Advanced Engineering Mathematics, John Wiley & Sons, New York, 5^{th} Edition, 1983, ISBN: 0-471-86251-7, page 773.

Other methods for combining information from both the authentic and spurious probability distributions are possible. One such method produces a scale with two regions. The regions are formed by the EER criterion, and represent the likelihood of a test item belonging to a particular class. The first region refers to test items unlikely to be authentic, and is simply a mapping onto a scale linear in probability, as described above, of the cumulative probability distribution from −∞ to the EER criterion of the spurious class output statistics. The second region refers to test items likely to be authentic, and is simply a mapping onto a scale linear in probability, as described above, of the cumulative probability distribution from the EER criterion to ∞ of the authentic class output statistics.

The mappings 63 produced by the NDS transform constructor 62 are used by another process in the course of classifying an unknown test item. The output statistics 66 produced by the pattern recognition system in operation 620 are subjected to the same kind of transformation done to output statistics in the NDS setup stage 610. Additional tests for unreasonable or unexpected values should be made in operation as well. The decision stage 65 is then presented with a single number from 0 to 100 inclusive, which comprehensively represents the output statistics 66 of the pattern recognition system in a context independent fashion.

A multiple class pattern recognition system will require an application of NDS once for every class of interest. For each class of interest, when pooling pattern recognition system output statistics, the remaining classes are all pooled into the class of spurious observations. The previous paragraphs describe the application of NDS for the simplest case where only the authentic and spurious distributions are produced by the pattern recognition system. The application of NDS may be repeated for multiple-class recognition systems without loss of generality.

I claim:

1. A method of reducing to one dimension the inherently multi-dimensional space of the error probabilities of a pattern classification system, comprising:
an analysis of the class-specific probability distributions; and
a mapping of the multi-dimensional space (a vector) to one dimension (a scalar).

2. A method according to claim 1, wherein the one dimensional space is modified, for example, to be a scale linear in probability.

3. A method according to claim 1, wherein the one dimensional space is based on likelihood in the original multi-dimensional space of error probabilities.

4. A method according to claim 1, wherein the one dimensional space is based on the ratio of probabilities of an error from the original multi-dimensional space of error probabilities.
